(19) United States
(12) Patent Application Publication
(10) Pub. No.: US 2022/0046413 A1
(43) Pub. Date: Feb. 10, 2022

(54) Mobile Originated Secure Message Transmission between a Subscriber Identity Module Application and a Cloud Server

(71) Applicant: OnePIN, Inc., Westborough, MA (US)

(72) Inventor: Marcin Nowak, Westborough, MA (US)

(21) Appl. No.: 17/390,895

(22) Filed: Jul. 31, 2021

Related U.S. Application Data
(60) Provisional application No. 63/059,321, filed on Jul. 31, 2020.

(51) Int. Cl. H04W 12/03; H04W 4/14; H04W 4/20; G06F 21/60; H04L 9/08; H04W 12/40; H04L 9/06

(52) U.S. Cl. CPC H04W 12/03; H04W 4/14; H04W 4/20; G06F 21/602; H04L 2209/80; H04L 9/0894; H04W 12/40; H04L 9/0631; H04L 9/0866

(57) ABSTRACT

A method and system for providing secure message transmission of messages between a subscriber identity module and a cloud server is disclosed. A keyset (keyset number, ciphering algorithm name, ciphering key value and cryptographic checksum algorithm name and key value, counter) is created in order to secure mobile-originated messages. An application on a SIM module of a mobile device receives the keyset via SMS message or via another data channel. The SIM module is triggered to send a mobile-originated message to the cloud server from the mobile device. Counter values are incremented, and cryptographic checksums are calculated if either process is used to secure the mobile-originated messages. Once the mobile-originated message is sent to the cloud server, the server uses the keyset to secure the message.

### PRIORITY

This application claims priority to U.S. Provisional Application No. 63/059,321, filed Jul. 31, 2020. The entire contents of that application are incorporated herein by reference.

### FIELD

This disclosure relates to message transmission between a mobile application and server platform. More particularly, this disclosure relates to secure message transmission between a subscriber identity module and a cloud server when short message service is used as the transport mechanism.

### BACKGROUND

Secure message transmission between a mobile application and a server platform is critical to protect against malicious activity. Over-The-Top (OTT) mobile terminals that a subscriber may download from a mobile application store (e.g., Apple's® App Store) use data traffic to communicate between the mobile application and the server. This data traffic can then be secured using industry standard encryption and security protocols such as Hypertext Transfer Protocol Secure (“HTTPS”) and signal protocol.

However, a standard approach to secure messages generated at the Subscriber Identity Module (“SIM”) when Short Message Service (SMS) messaging is used as the transport mechanism does not exist within the mobile or data encryption industries. Such an absence in the art of data security is limiting to those wishing to use mobile devices for secure communications, and could result in breaches of personal information if such communications are not properly secured.

In situations where SMS is not used, there are existing security mechanisms in place. For example, if a data connection is established between the SIM card and the server, data can be encrypted and secured using standard data security approaches. Specifically, if BIP (Bearer Independent Protocol) is used as the data connection mechanism between an application that resides on the SIM and a server, then messages can be secured. However, few mobile devices widely support connections such as BIP. As a result, Mobile Operators and service providers use SMS as the default transport mechanism to communicate with applications on a mobile subscriber's SIM card. Such communications frequently lack security.

While Mobile Terminated (MT) messages can be secured using approaches defined within the GSM 3GPP 03.48 foundational security standard, and specifically the more current TS 23.040 standard, this approach only defines and only works for messages sent from a server platform that terminate at the mobile application on the SIM card. If an application on the SIM card creates an SMS message and relays it to a cloud platform, there is currently no standard method defined to secure such messages. The Global Platform Card Specification outlines an approach whereby a Global Platform Security Domain is utilized to isolate an application on the SIM card from other applications on the SIM card, and to send secure mobile terminated messages. However, this Specification does not however define a process for securing mobile-originated messages.

The focus of securing messages within the industry has largely been on the MT path. Specifically, developers and network providers secure messages sent from a platform to the SIM card to prevent unauthorized entities from triggering or taking control of an application on the SIM card. Mobile Connect specifications within the industry also focus on messaging sent from the server to the application in order to deliver mobile health records, or account login credentials, as an example. No secure path originating from the SIM has been defined in the instance when SMS is used as the transmission protocol. This limits use cases, such as the ability to collect sensitive information from the mobile subscriber. Sensitive information could include personal data, contact information, or credit card details.

Therefore, a need exists for a method and system for securing messages generated at the SIM card level and sent to a cloud server platform when SMS messaging is used as the transport mechanism.

### SUMMARY

One aspect of this disclosure provides a computer-implemented method of creating an encryption module on a SIM card installed on a mobile device. The method comprises the steps of receiving, at a server operably connected to a mobile network, an unencrypted message from an application installed on the SIM card; creating, at the server, a keyset for an Integrated Circuit Card Identifier associated with the SIM card; sending an encrypted message comprising the keyset to the mobile device, wherein the keyset is configured to encrypt messages sent from the application installed on the SIM card; and storing, at the server or a memory location operably coupled to the server, the keyset and an association between the keyset and the ICCID. In some embodiments, the keyset is stored at the server for a specified time period.

The method may further comprise the step of receiving at the server a message from the mobile device, wherein the message confirms receipt of the keyset. The method may also further comprise the step of counting, at the server, the number of messages encrypted with the keyset and sent from the mobile device. In some embodiment, the server sends a second keyset to the mobile device when the count of the number of times the keyset was used to encrypt a message exceeds a predefined limit.

Yet another aspect of this disclosure provides a system for encrypting messages sent between an application installed on a SIM card and a server. The system comprises a server comprising a network interface configured to communicate with a plurality of mobile devices; a processing module comprising instructions configured to generate a keyset, to execute a level and type of encryption, to encrypt messages, and to execute a cryptographic algorithm. The server also comprises a memory module configured to store an Integrated Circuit Card Identifier (“ICCID”) value, a Mobile Station International Subscriber Directory Number (“MSISDN”) value, an association between the ICCID value and the MSISDN value, a keyset, an association between the ICCID and the keyset, a level and type of encryption, and a cryptographic algorithm. At the server, the network interface, processing module, and memory module are operably connected. The system also comprises a mobile device comprising a mobile network interface configured to communicate with the server; a Subscriber Identity Module (“SIM”) comprising an ICCID and an MSISDN; a SIM memory module configured to store the keyset, the level and type of encryption, and the cryptographic algorithm; and a SIM application installed on the SIM and configured to execute instructions to use the keyset and cryptographic algorithm to encrypt and send encrypted messages and execute instructions to use the keyset and cryptographic algorithm to decrypt received encrypted messages. At the mobile device, the SIM, the SIM application, the SIM memory module, and the mobile network interface are operably connected.

In some embodiments, the system is configured to use AES-256 to encrypt messages.

Another aspect of this disclosure provides a method for sending an encrypted message from an application installed on a SIM card installed on a mobile device. The method comprises the steps of sending, from the application installed on the SIM card, a provisioning message over a mobile network. In some embodiments, the provisioning message is not encrypted because the mobile device has not yet received an encryption key. The method comprises receiving a keyset at the mobile device that is configured to encrypt messages sent from an application installed on the SIM card; storing the keyset in a memory module on the mobile device; encrypting a message sent from the application using the keyset; and sending the encrypted message from the application over a mobile network.

In some embodiments, the keyset is configured to be valid for a certain amount of time. In some embodiments, the keyset is configured to be valid for a certain number of messages. In other embodiment, the keyset is configured to be valid for a certain amount of time and a certain number of messages and loses its validity depending on whichever occurs first.

Yet another aspect of this disclosure provides a mobile device configured to send and receive encrypted messages between an application installed on a SIM card installed on a mobile device and a server. The mobile device comprises a SIM comprising an ICCID and an MSISDN; a SIM application installed on the SIM, wherein the SIM application is configured to use a keyset to encrypt a message prior to sending the message to a server; a memory module configured to store a keyset received from the server; and a network interface configured to communicate with the server to send the encrypted message. At the mobile device, the SIM, SIM application, memory module, and network interface are operably connected.

### BRIEF DESCRIPTION OF THE FIGURES

FIG. 1 is a block diagram of a mobile device according to an embodiment of the disclosure.

FIG. 2 is a block diagram of a cloud server according to an embodiment of the disclosure.

FIG. 3 is a flow diagram illustrating an embodiment of the keyset management method from the perspective of the server.

FIG. 4 is a flow diagram illustrating an embodiment of the message transmission method from the perspective of the mobile device.

### DETAILED DESCRIPTION

This disclosure provides methods and systems for securing message transmission between a SIM application and a cloud server platform. This disclosure provides methods and systems to protect data during transit over a cellular or data network, while still enabling the entity controlling the cloud environment to process the data entered by on a mobile device and sent from a SIM application to the server, or sent automatically from an application on the SIM to the server.

The term “SIM” or “SIM card” may include a USIM, eSIM, iSIM, or any other technical iteration or manifestation of SIM technology. All physical form factors including mini SIM, nano SIM, micro SIM, and other future form factors are also intended to be captured by the term “SIM” or “SIM card”. Software-only SIM environments may also be included within the term SIM and within the context of this application, as the SIM environment and technology does not need to be limited to a physical card or element.

As used herein, the indefinite articles “a” and “an” mean one or more than one.

In the methods and systems of this disclosure, a keyset is created at a server to secure mobile-originated messages. In some embodiments, a set of random key values is generated and assigned on the server side for a particular mobile subscriber. In some embodiments, the encryption protocol used is AES256 (“Advanced Encryption Standard-256”) and a 256-bit long encryption key value is generated. In some embodiments, the required 32 random bytes can be calculated using one of the deterministic random bit generator methods described under NIST SP800-90A Rev. 1, for example: HMAC_DRBG. In some embodiments, the cryptographic checksum algorithm is AES256 and a 256-bit long key is generated using the same methodology (for example: HMAC_DRBG). In some embodiments, the keyset comprises the encryption key and cryptographic algorithm sent to the mobile application.

In some embodiments, a set of random key values are generated at the mobile device. The keys are linked to the mobile subscriber's ICCID (Integrated Circuit Card Identifier), which is the unique serial number linked to the SIM card. The server stores relationships between ICCID and MSISDN values. The keyset generated at the server is sent to the SIM card and stored in a memory module on the mobile device. In some embodiments, the keyset is stored on the card within a target SIM application.

In some embodiments, multiple keysets for an ICCID are stored at the server.

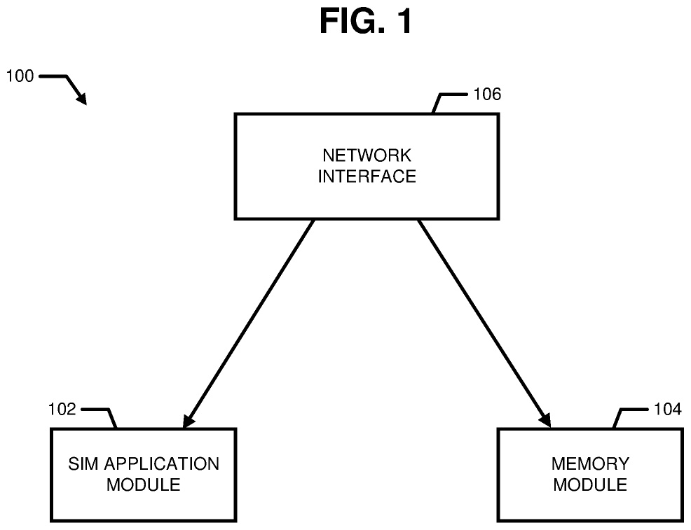

FIG. 1 is a block diagram of a mobile device according to an embodiment of the disclosure. Mobile device 100 includes a SIM application 102. This application may comprise an applet.

Mobile device 100 also includes a memory module 104. Memory module 104 and SIM application 102 are communicatively coupled to the network interface 106. Network interface 106 is communicatively coupled to any cloud server, local area network or wide area network. Memory module 104 is configured to hold the keyset and can also be configured to store the level and type of encryption and cryptographic checksum algorithm associated with secure messaging from the mobile device 100. In some embodiments, a cryptographic checksum algorithm is used to create a mathematical value that is assigned to a message and then later that cryptographic algorithm is used to check the message to verify that the message has not been modified. In some embodiments, SIM application 102 is configured to verify if the parameters of a keyset are supported by the SIM.

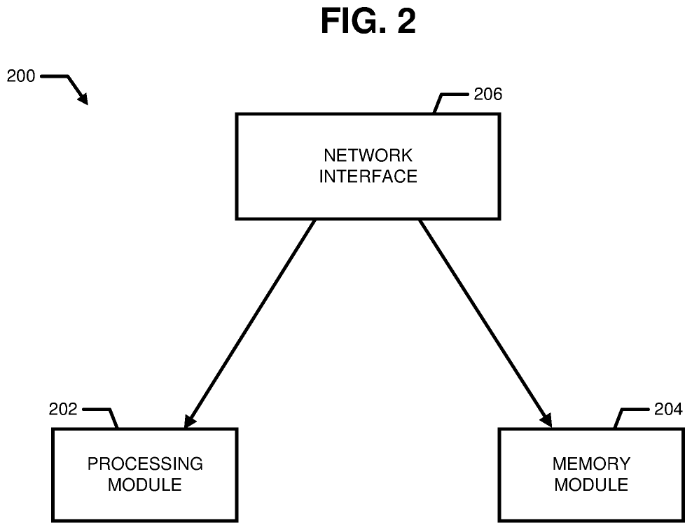

FIG. 2 is a block diagram of a cloud server according to an embodiment of the disclosure. Cloud server 200 (or “server”) comprises a server, and includes processing module 202. Processing module 202 comprises instructions for executing the level and type of encryption and cryptographic checksum algorithm that could be associated with a specific mobile subscriber's SIM card application depending on the integrated circuit card identifier (“ICCID”) or Mobile Station International Subscriber Directory Number (“MSISDN”) values.

Cloud server 200 also includes a memory module 204. The cloud server 200 stores relationships between ICCID and MSISDN values in the memory module 204, including keysets, level and type of encryption, or cryptographic checksum algorithm. Memory module 204 and processing module 202 are communicatively coupled to the network interface 206, which is communicatively coupled to any mobile device via any local area network or wide area network. Whether or not mobile-originated messages are secured can be defined within the memory module 204 of the cloud server 200. The setting can be enabled and disabled in the SIM application, managed by a communication sent to the SIM applet from the server in a type of remote control. In some embodiments, a remote control command could be generated at the cloud server and contained within a mobile terminated binary class-2 SMS message that is directed at the SIM application on the SIM card. The message contains commands configured to be carried out by the SIM application, thereby allowing the application to be controlled in a remote control fashion from the cloud server in certain embodiments.

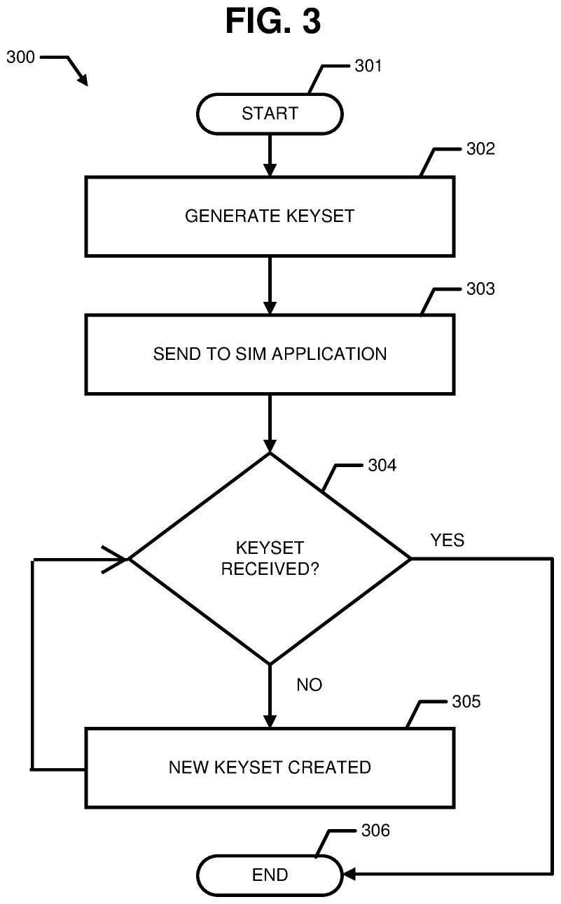

FIG. 3 is a flow diagram illustrating an embodiment of the keyset management method 300 from the perspective of cloud server 200. Method 300 commences with SIM application 102 on a mobile device 100 provisioning with a cloud server. During the provisioning process, the SIM application communicates directly with the cloud server sending a specifically formatted message that the cloud server recognizes as a provisioning message. In some embodiments, the provisioning process comprises a first mobile-originated SMS message sent from the SIM application to the server. In some embodiments, this could be a binary SMS containing information about the mobile user's device type and SIM software application version. In other embodiments, this could be a data-based web connection where similar information is sent to the cloud server from the SIM application. In some embodiments, the provisioning message comprises information to aid the cloud server in recognizing that it is a first attempt at provisioning, or a repeated attempt at provisioning. Typically, the first provisioning message is unencrypted because the SIM card will not yet have received any keys from the server. However, because this message does not include sensitive information, encryption of this message is not critical.

Once provisioning step 301 is complete, method 300 proceeds to step 302 and generates a keyset at server 200. The keyset may comprise any of the following, either alone or in combination: a keyset number, ciphering algorithm name, ciphering key value, cryptographic checksum, or counter values. This keyset is then generated at the server, and sent (e.g., via a Mobile Terminated (MT) message 3GPP TS 23.040) back to the SIM application. The keyset may also be sent to the SIM application on the mobile device from the server via a SMS message or via another data channel at step 303.

The keyset is stored at the server and remains valid for a configurable period of time. For example, the keyset can be valid for a period of days, weeks, months, or years or for some period of mobile service. In some embodiments, the keyset is valid for a certain number of messages sent. In some embodiments, the keyset can be valid for a combination of time or certain number of messages. In certain embodiments, the keyset expires when either the time period expires or the number of messages is met. In other embodiments, a standard (preloaded) keyset per Mobile Operator can be used for the first Mobile-originated message such that the message is encrypted. This preloaded keyset would reside on the SIM. The key validity of the preloaded keyset is also configurable.

In some embodiments, the application on the SIM card is configured to remain silent, and non-functional, until a response with a valid keyset is received from the server. In some embodiments, the application on the SIM could execute a series of initial provisioning steps prior to being active. A provisioning message could be sent to the server, and once a provisioning response is received with a key that will be used to secure mobile-originated messages, then the applet is active. Until that point, the application can be configured to ignore any messages received from the platform.

The keyset used to secure mobile-originated messages may be the same or may be different from the keyset used to encrypt mobile terminated messages sent to the application. The keyset and encryption method are independent of the transport mechanism used to deliver messages to the SIM. While the focus of this application is SMS, data connections and bearer independent protocol (BIP) are also within the scope of this disclosure. The keyset and encryption processes can be used with SMS as well as non-SMS data connections.

In some embodiments, a single keyset is used to encrypt all mobile-originated messages. Even if the mobile subscriber changes devices and ports the SIM card, the same key can still be utilized because the server recognizes the ICCID associated with the SIM. In other embodiments, a new keyset may be generated at the server and delivered to the SIM application after each mobile-originated communication in a dynamic key allocation scenario. A synchronization mechanism is utilized to ensure that the active keyset at the server is the same as that within the SIM application. In still other embodiments, a new keyset may be generated at the server and delivered to the SIM application after the previous keyset is expired (configurable time period or certain number of messages sent with the keyset). A synchronization mechanism is utilized to ensure that the active keyset at the server is the same as that within the SIM application.

The keyset generated at the server is sent via a secured message comprising the keyset to the application installed on the SIM via SMS or a data channel. In some embodiments, the message sent to the SIM card is secured according to 3GPP TS 23.040 security standards, meaning the following security elements are utilized: strong encryption (for example AES256); strong cryptographic checksum (for example AES256); replay detection and Sequence Integrity counter.

When the keyset is sent from the server to the SIM application, the definition of the encryption algorithm is also sent, which provides flexibility for the utilization of different algorithms within the same implementation. This flexibility enables the system to utilize strong encryption algorithms for newer SIM cards as these algorithms are defined within the ecosystem. Any suitable type of encryption and cryptographic checksum algorithm could be used, including but not limited to AES or 3DES.

Method 300 proceeds to inquiry step 304 to determine if the keyset was received by the SIM application 102 on mobile device 100. This determination may include a number of suitable processes, including employment of a receipt mechanism, receipt of an acknowledgement message from the SIM application 102 by the cloud server, or the determination that a bounceback did not occur when sending the keyset to mobile device 100. In some embodiments, there could be an internal confirmation message between the SIM application and the server confirming the “handshake” or successful delivery of the keyset. To ensure synchronization, a message delivery report can also be monitored within the network to determine if a message with a keyset was successfully delivered to the SIM.

If the keyset was not successfully received by SIM application 102, then the cloud server sends a second keyset at step 305. In some embodiments, this step repeats until confirmation that the keyset was successfully received by the SIM application. In other embodiments, not shown in FIG. 3, there is no confirmation that the keyset was successfully received by the SIM application. Multiple keysets for an integrated circuit card identifier (ICCID) associated with a mobile device are stored at the server side (at least last two keysets are generated), in the event that one of the messages with a keyset sent to the application could not be successfully delivered. All mobile-originated messages sent to the server will contain the ICCID such that processing at the server can match the specific SIM card with the correct keyset stored at the server. Notably, MSISDN (on the SIM) can be changed dynamically, but ICCID (the serial number of the SIM card) cannot be changed. If the keyset is successfully received at inquiry step 304, then method 300 terminates at step 306. With the keyset generated and received at the mobile device, the mobile device is configured to send a secured message to the cloud server.

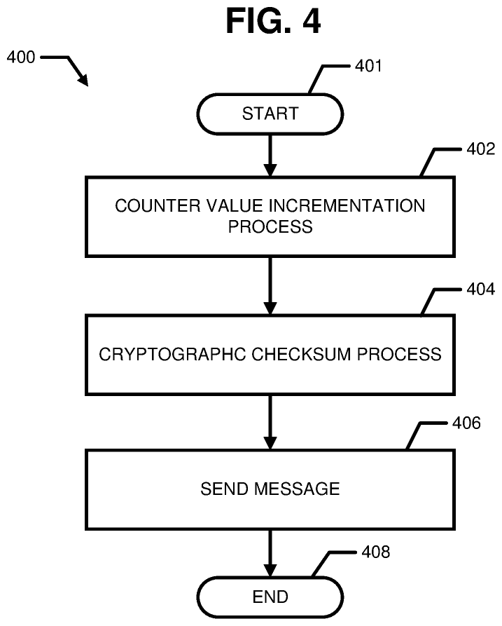

FIG. 4 is a flow diagram illustrating an embodiment of the message transmission method from the perspective of the mobile device. Method 400 begins at keyset inquiry step 401 when the SIM application 102 is triggered to send a mobile-originated message to cloud server 200. Method 400 commences if the keyset stored in memory module 104 is not expired. At step 401, the mobile device determines whether the keyset has met its expiry configuration, e.g., whether the keyset has been used for a specified number of messages or for a specified duration of time. If the keyset is expired, the mobile device will need to acquire a new keyset from the cloud server, as described above and shown in an exemplary embodiment in FIG. 3. In some embodiments, SIM application 102 will replace an existing keyset with the new keyset that was just received.

At step 402, in some embodiments, counter values are incremented via a counter value incrementation process if counter values were used to secure the mobile-originated message. To effectuate this feature, a counter is kept at the application or at server 200 or both. The counter counts the number of messages encrypted with the keyset. After a pre-defined number of messages have been sent using the keyset, the keyset expires. Once the keyset expires, the server generates a new keyset as described above and sends it to the application. In some instances, as described above, the keyset can be configured to last for a specific amount of time in addition to, or instead of, lasting for a certain number of messages.

At step 404, cryptographic checksums are calculated via a cryptographic checksum process if used to secure the mobile-originated messages. Once completed, in some embodiments, the mobile device prepends the aforementioned counter value to the clear text payload and sends the secure mobile-originated message to the cloud server at step 406. In certain embodiments, mobile-originated message is encrypted when counter values and cryptographic checksum are completed. Method 400 terminates at step 408.

From the server's perspective, the server extracts the keyset and encrypted payload from the message received from method 400. The message is decrypted according to the keyset number and encryption algorithm associated with the ICCID, if keyset utilizes encryption. The message counter value is verified, and the cryptographic checksum is confirmed to be correct, if the keyset utilizes a cryptographic checksum. If the message counter value is incorrect and/or the cryptographic checksum is incorrect, no further processing occurs at the server.

In one embodiment, even if the SIM application has been configured to send non-secure (nonencrypted) mobile-originated messages, an override setting can be configured. In this embodiment, a specific communication that will be sent back to the server is encrypted. In one embodiment, the SIM application may have a default setting to send mobile-originated messages to the server that are not secured. However, an enterprise or a mobile operator may wish to send an engagement to a mobile subscriber where the response back to the server should be secure. Specifically, a mobile end user may be asked to input credit card details into a prompt from the SIM application. To ensure that the information remains secure when sent to the server, the engagement communication initially sent to the mobile subscriber could contain keyset information and details that a response sent back to the server can only be sent if the message is secured. The engagement communication can contain instructions that instruct the application to secure a response message using the keyset. In some embodiments, when communications are sent from the SIM application to the server, the message payload is not visible in clear text in the event that the message is traced or spied. Only the keyset number value is exposed.

It will be understood by the skilled reader that variations may be made to the above-described embodiments without departing from the scope of the present invention. While the disclosure has been particularly shown and described with reference to the embodiments illustrated in the drawings, it will be understood by one skilled in the art that various changes in detail may be affected therein without departing from the spirit and scope of the disclosure as defined by the claims.

1. A computer-implemented method of creating an encryption module on a SIM card installed on a mobile device, the method comprising:
receiving, at a server operably connected to a mobile network, an unencrypted message from an application installed on the SIM card;
creating, at the server, a keyset for an Integrated Circuit Card Identifier associated with the SIM card;
sending an encrypted message comprising the keyset to the mobile device, wherein the keyset is formatted to encrypt messages sent from the application installed on the SIM card; and
storing, at the server or a memory location operably coupled to the server, the keyset and an association between the keyset and the ICCID.

2. The method of claim 1, further comprising storing the keyset at the server for a specified time period.

3. The method of claim 1, further comprising receiving at the server a message from the mobile device, wherein the message confirms receipt of the keyset.

4. The method of claim 1, further comprising counting, at the server, the number of messages encrypted with the keyset and sent from the mobile device.

5. The method of claim 4, further comprising sending, from the server, a second keyset to the mobile device when the count of the number of times the keyset was used to encrypt a message exceeds a predefined limit.

6. A system for encrypting messages sent between an application installed on a SIM card and a server, comprising:
a server comprising:
a network interface configured to communicate with a plurality of mobile devices;
a processing module comprising instructions configured to generate a keyset;
to execute a level and type of encryption;
to encrypt messages; and
to execute a cryptographic algorithm;
a memory module configured to store an Integrated Circuit Card Identifier value, a Mobile Station International Subscriber Directory Number values, an association between the ICCID value and the MSISDN value, a keyset, an association between the ICCID and the keyset, a level and type of encryption, and a cryptographic algorithm;
wherein the network interface, processing module, and memory module are operably connected;
a mobile device comprising:
a mobile network interface configured to communicate with the server;
a Subscriber Identity Module comprising an ICCID and an MSISDN;
a SIM memory module configured to store the keyset, the level and type of encryption, and the cryptographic algorithm; and
a SIM application installed on the SIM and configured to:
execute instructions to use the keyset and cryptographic algorithm to encrypt and send encrypted messages; and
execute instructions to use the keyset and cryptographic algorithm to decrypt received encrypted messages;
wherein the SIM, the SIM application, the SIM memory module, and the mobile network interface are operably connected.

7. The system of claim 6, wherein the system is configured to use AES-256 to encrypt messages.

8. A method of sending an encrypted message from an application installed on a SIM card installed on a mobile device, the method comprising:
sending, from the application installed on the SIM card, over a mobile network a provisioning message;
receiving, at the mobile device, a keyset, wherein the keyset is configured to encrypt messages sent from an application installed on the SIM card;
storing the keyset in a memory module on the mobile device;
encrypting a message sent from the application using the keyset; and
sending the encrypted message from the application installed on the SIM over a mobile network.

9. The method of claim 8, wherein the keyset is configured to be valid for a certain amount of time.

10. The method of claim 8, wherein the keyset is configured to be valid for a certain number of messages.

11. A mobile device configured to send and receive encrypted messages between an application installed on a SIM card installed on a mobile device and a server, the mobile device comprising:
a Subscriber Identity Module comprising an ICCID and MSISDN;
a SIM application installed on the SIM, wherein the SIM application is configured to use a keyset to encrypt a message prior to sending the message to a server;
a memory module configured to store a keyset received from the server; and
a network interface configured to communicate with the server to send the encrypted message, wherein the SIM, SIM application, memory module, and network interface are operably connected.
